(19) United States
(12) Patent Application Publication
(10) Pub. No.: US 2016/0093840 A1
(43) Pub. Date: Mar. 31, 2016

(54) PACKAGING FILM FOR POWER STORAGE DEVICE, TUBE-TYPE PACKAGING MEMBER, AND POWER STORAGE DEVICE

(71) Applicant: SHOWA DENKO PACKAGING CO., LTD., Isehara-shi (JP)

(72) Inventor: Kenji YOSHINO, Isehara-shi (JP)

(21) Appl. No.: 14/861,044

(22) Filed: Sep. 22, 2015

(30) Foreign Application Priority Data
Sep. 25, 2014 (JP) 2014-194969

(51) Int. Cl. H01M 2/02; H01M 10/0525

(52) U.S. Cl. CPC H01M 2/0287; H01M 2/0275; H01M 10/0525; H01M 2002/0297

(57) ABSTRACT

A packaging film is formed by a laminated film including a plurality of layers, and is configured to be bent into a tube-shape to form a tube-type packaging member having flexibility. Further, the packaging film includes an innermost layer, an outermost layer, and a barrier layer arranged between innermost layer and the outermost layer, as the plurality of layers. The barrier layer is a metallic layer. The innermost layer and the outermost layer are each formed by a thermal fusion resin layer. An adhesive agent bonding overlapped adjacent layers of the plurality of layers has electrolyte resistance.

### CROSS-REFERENCE TO RELATED APPLICATIONS

The present application claims priority to Japanese Patent Application No. 2014-194969 filed on Sep. 25, 2014, the disclosure of which is incorporated herein in its entirety.

### BACKGROUND OF THE INVENTION

1. Field of the Invention

The present disclosure relates to a packaging film for a power storage device (e.g., a lithium-ion secondary battery, an electric double layer capacitor) having flexibility, a tube-type packaging member for a power storage device, and a power storage device.

2. Description of the Related Art

For example, in a lithium-ion secondary battery as a power storage device, it is equipped with battery elements including an electrode (current collector) and an electrolyte (electrolyte solution). The battery elements are accommodated in a packaging member formed into, e.g., a bag shape, a container shape, etc., in a sealed manner. A packaging film used as a packaging material forming a packaging member is required to have high barrier performance against gases, water vapors, liquids, etc. For this reason, a packaging film is generally formed by a laminated film including at least a metallic layer as a plurality of layers, and the plurality of layers are integrally bonded by, for example, a dry lamination method. In detail, the adjacent layers in the plurality of layers are bonded by an adhesive agent interposed therebetween.

In recent years, a flexible linear (string type) secondary battery is attracting attention, and Japanese Unexamined Patent Application Publication (Translation of PCT Application) No. 2014-509054 discloses a covering material for covering an electrode assembly (battery element) of such a secondary battery. Further, Japanese Unexamined Patent Application Publication No. 2004-281156 discloses a power storage container used as a non-flexible secondary battery, etc. The container is provided with a cylindrical moisture-proof sheet including an aluminum foil, but a cylindrical resin solid container is arranged inside the moisture-proof sheet for providing electrolyte resistance to the container. Therefore, the power storage container lacks flexibility.

A packaging member used for a flexible linear secondary battery is of a generally tube-shape, and is required to have flexibility. As a method of forming such packaging member by a packaging film, the present inventors conceived to form a tube-type packaging member by bending a packaging film having a first end portion and a second end portion in a bending direction into a tube-shape, overlapping an inner surface of the second end portion on the outer surface of the first end portion, and bonding both the end portions in the overlapped state.

However, in the tube-type packaging member obtained as mentioned above, the end face of the first end portion of the packaging film is exposed on the inner side of the tube-type packaging member. For this reason, the adhesive agent bonding layers constituting the packaging film is eroded from the end face of the first end portion of the packaging film by the electrolyte contained in the battery element accommodated in the packaging member with time. As a result, a delamination phenomenon, etc., may occur in the packaging member (packaging film) to cause deterioration of the barrier performance.

The description herein of advantages and disadvantages of various features, embodiments, methods, and apparatus disclosed in other publications is in no way intended to limit the present invention. For example, certain features of the preferred described embodiments of the invention may be capable of overcoming certain disadvantages and/or providing certain advantages, such as, e.g., disadvantages and/or advantages discussed herein, while retaining some or all of the features, embodiments, methods, and apparatus disclosed therein.

### SUMMARY OF THE INVENTION

The disclosed embodiments of the present invention have been developed in view of the above-mentioned and/or other problems in the related art. The disclosed embodiments of the present invention can significantly improve upon existing methods and/or apparatuses.

Some embodiments of the present invention were made in view of the aforementioned technical background, and aim to provide a packaging film for a power storage device capable of producing a flexible packaging member long in service life, a flexible tube-type packaging member for a power storage device long in service life, or a power storage device equipped with a flexible tube-type packaging member long in service life. Another purposes and advantages of some embodiments of the present invention will become apparent from the following embodiments.

Some embodiments of the present invention provide the following means.

[1] A packaging film for a power storage device including a laminated film including a plurality of films, the laminated film being configured to be bent into a tube-shape to form a tube-type packaging member having flexibility,

wherein the plurality of films includes an innermost layer, an outermost layer, a barrier layer arranged between the innermost layer and the outermost layer, as a plurality of layers,

wherein the barrier layer is a metallic layer,

wherein the innermost layer and the outermost layer are each a thermal fusion resin layer, and

wherein an adhesive agent bonding overlapped layers of the plurality of layers has electrolyte resistance.

[2] The packaging film as recited in the aforementioned Item [1], wherein the adhesive agent is at least one adhesive agent selected from the group consisting of a polyolefin-based adhesive agent, an epoxy-based adhesive agent, a fluorine-based adhesive agent, and a polyurethane-based adhesive agent.

[3] The packaging film as recited in the aforementioned Item [1] or [2], wherein the metallic layer is formed by a metallic foil subjected to a chemical conversion treatment.

[4] The packaging film as recited in any one of the aforementioned Items [1] to [3],

wherein the plurality of layers further includes an intermediate layer arranged at least either between the innermost layer and the barrier layer and between the barrier layer and the outermost layer, and

wherein the intermediate layer is formed by at least one film selected from the group consisting of a polyester-based resin film and a polyamide-based resin film.

[5] A tube-type packaging member for a power storage device, including:

the packaging film as recited in the aforementioned Item [1],

wherein the packaging film is bent into a tube-shape, the packaging film including a first end portion and a second end portion in a bending direction, and

wherein, in a state in which the first end portion of the packaging film and the second end portion of the packaging film are overlapped, the first end portion and the second end portion are heat-welded.

[6] The tube-type packaging member as recited in the aforementioned Item [5],

wherein, in a state in which an outer surface of the first end portion of the packaging film is overlapped on an inner surface of the second end portion of the packaging film, the inner surface of the second end portion is heat-welded to the outer surface of the first end portion.

[7] The tube-type packaging member as recited in the aforementioned Item [6],

wherein an end face of the first end portion of the packaging film and the inner surface of the second end portion are heat-welded.

[8] The tube-type packaging member as recited in the aforementioned Item [5],

wherein, in a state in which an inner surface of the first end portion of the packaging film and an inner surface of the second end portion of the packaging film are overlapped, and the first end portion is folded outwardly of the packaging film so that an outer surface of the first end portion is overlapped on an outer surface of the packaging film, the inner surface of the first end portion and the inner surface of the second end portion are heat-welded, and the outer surface of the first end portion is heat-welded to the outer surface of the packaging film.

[9] The tube-type packaging member as recited in the aforementioned Item [5],

wherein, in a state in which an outer surface of the first end portion of the packaging film and an outer surface of the second end portion of the packaging film are overlapped, and the first end portion is folded inwardly of the packaging film so that an inner surface of the first end portion is overlapped on an inner surface of the packaging film, the outer surface of the first end portion and the outer surface of the second end portion are heat-welded, and the inner surface of the first end portion is heat-welded to the inner surface of the packaging film.

[10] The tube-type packaging member as recited in any one of the aforementioned Items [5] to [9],

wherein the adhesive agent is at least one adhesive agent selected from the group consisting of a polyolefin-based adhesive agent, an epoxy-based adhesive agent, a fluorine-based adhesive agent, and a polyurethane-based adhesive agent.

[11] The tube-type packaging member as recited in any one of the aforementioned Items [5] to [10], wherein the metallic layer is formed by a metallic foil subjected to a chemical conversion treatment.

[12] The tube-type packaging member as recited in any one of the aforementioned Items [5] to [11], wherein the plurality of layers further includes an intermediate layer arranged at least either between the innermost layer and the barrier layer and between the barrier layer and the outermost layer, and

wherein the intermediate layer is formed by at least one film selected from the group consisting of a polyester-based resin film and a polyamide-based resin film.

[13] A power storage device, comprising:

the tube-type packaging member as recited in the aforementioned Item [5]; and

a power storage device element having flexibility,

wherein the power storage device is accommodated in the tube-type packaging member.

[14] The power storage device as recited in the aforementioned Item [13],

wherein, in a state in which an outer surface of the first end portion of the packaging film is overlapped on an inner surface of the second end portion of the packaging film, the inner surface of the second end portion is heat-welded to the outer surface of the first end portion.

[15] The power storage device as recited in the aforementioned Item [14],

wherein an end face of the first end portion of the packaging film and the inner surface of the second end portion are heat-welded.

[16] The power storage device as recited in the aforementioned Item [13],

wherein, in a state in which an inner surface of the first end portion of the packaging film and an inner surface of the second end portion of the packaging film are overlapped, and the first end portion is folded outwardly of the packaging film so that an outer surface of the first end portion is overlapped on an outer surface of the packaging film, the inner surface of the first end portion and the inner surface of the second end portion are heat-welded, and the outer surface of the first end portion is heat-welded to the outer surface of the packaging film.

[17] The power storage device as recited in the aforementioned Item [13],

wherein, in a state in which an outer surface of the first end portion of the packaging film and an outer surface of the second end portion of the packaging film are overlapped, and the first end portion is folded inwardly of the packaging film so that an inner surface of the first end portion is overlapped on an inner surface of the packaging film, the outer surface of the first end portion and the outer surface of the second end portion are heat-welded, and the inner surface of the first end portion is heat-welded to the inner surface of the packaging film.

According to the embodiment of the present invention as recited in the aforementioned Item [1], the innermost layer and the outermost layer of the packaging film are each made of a thermal fusion resin layer. Thus, by bending the packaging film into a tube-shape, both end portions of the packaging film in the bending direction can be joined by heat-welding in various joint manners.

Further, since the adhesive agent has electrolyte resistance, even in cases where an end face of the first end portion of the packaging film is exposed to the inside of the tube-type packaging member in a state in which both end portions of the packaging film are bonded, it becomes possible to control erosion of the adhesive agent by the electrolyte at the end face of the first end portion of the packaging film. With this, the service life of the packaging member can be extended.

According to the embodiment of the present invention as recited in the aforementioned Item [2], erosion of the adhesive agent by the electrolyte can be controlled assuredly. With this, the service life of the packaging member can be extended assuredly.

According to the embodiment of the present invention as recited in the aforementioned Item [3], erosion of the metallic layer by the electrolyte can also be controlled. With this, the service life of the packaging member can be extended assuredly.

According to the embodiment of the invention as recited in the aforementioned Item [4], since the intermediate layer is made of a prescribed resin layer, the durability of the packaging film against an external force (piercing, bending, tension, etc.) can be improved. With this, the service life of the packaging member can be further extended.

According to the embodiment of the invention as recited in the aforementioned Items [5] to [12], a flexible tube-type packaging member having a long service life can be provided.

Further, according to the embodiment of the invention as recited in the aforementioned Item [7], since the end face of the first end portion of the packaging film is heat-welded to the inner surface of the second end portion, at the end face of the first end portion of the packaging film, occurrence of erosion of the metallic layer by the electrolyte can be prevented, and erosion of the adhesive agent by the electrolyte can be further controlled. With this, the service life of the packaging member can be further extended.

Further, according to the embodiment of the present invention as recited in the aforementioned Item [8], since both of the end face of the first end portion of the packaging film and the end face of the second end portion of the packaging film are arranged on the outside of the packaging member without being arranged on the inner side of the packaging member, there is no possibility that the adhesive agent is eroded by the electrolyte at the end face of each end portion of the packaging film. With this, the service life of the packaging member can be dramatically extended. Further, since the outer surface of the first end portion of the packaging film is heat-welded to the outer surface of the packaging film, the head-welding can be performed easily.

According to the embodiment of the present invention as recited in the aforementioned Items [13] to [17], a flexible power storage device equipped with a tube-type packaging member high in service life can be provided.

### BRIEF DESCRIPTION OF THE DRAWINGS

Embodiments of the present invention are shown by way of example, and not limitation, in the accompanying figures.

FIG. 1 is a schematic cross-sectional view showing a tube-type packaging member for a power storage device according to a first embodiment of the present invention.

FIG. 2 is a schematic enlarged cross-sectional view of a packaging film used as a packaging material in the packaging member.

FIG. 3 is a schematic cross-sectional view of a tube-type packaging member for a power storage device according to a second embodiment of the present invention.

FIG. 4A is a schematic cross-sectional view of a tube-type packaging member for a power storage device according to a third embodiment of the present invention.

FIG. 45 is a schematic cross-sectional view of a tube-type packaging member for a power storage device according to the third embodiment of the present invention showing a state in which the packaging member is being produced.

FIG. 5 is a schematic cross-sectional view of a tube-type packaging member for a power storage device according to a fourth embodiment of the present invention.

FIG. 6 is a schematic enlarged cross-sectional view of a packaging film according to another embodiment of the present invention.

FIG. 7 is a schematic enlarged cross-sectional view of a packaging film according to still another embodiment of the present invention.

### EMBODIMENTS FOR CARRYING OUT THE INVENTION

In the following paragraphs, some embodiments of the present invention will be described by way of example and not limitation. It should be understood based on this disclosure that various other modifications can be made by those in the art based on these illustrated embodiments.

Next, some embodiments of the present invention will be explained with reference to the attached drawings.

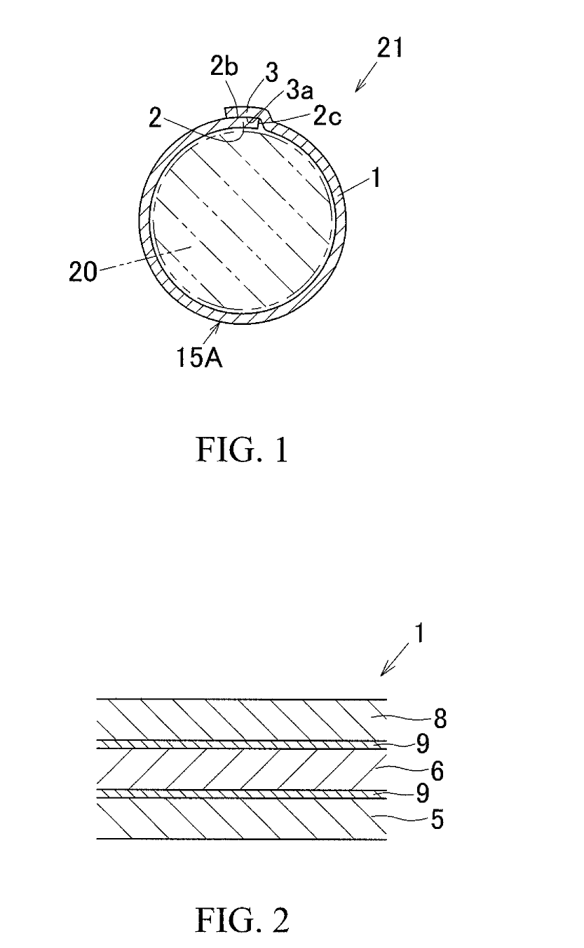

FIG. 1 shows a tube-type packaging member 15A for a power storage device according to a first embodiment of the present invention. The packaging member 15A is configured to accommodate a linear lithium-ion secondary battery element 20 (shown by two-dot chain lines) with flexibility as a power storage device element, and has flexibility. The cross-sectional shape of the packaging member 15A is a substantially circular shape. The battery element 20 includes a positive electrode, a negative electrode, an electrolyte, etc. As the electrolyte, a liquid electrolyte (e.g., an electrolyte solution), a solid electrolyte (e.g., polymer electrolyte), etc., may be used. In this embodiment, for example, an electrolyte solution can be used as the electrolyte.

The length and the outer diameter of the packaging member 15A are not specifically limited, but are set depending on the size of the battery element 20. For example, the outer diameter of the packaging member 15A may be set to 2 mm to 20 mm.

The packaging film 1 used as the packaging material of the packaging member 15A is formed by a laminated film including a plurality of layers as shown in FIG. 2, and has flexibility. Further, the packaging film 1 includes, as the plurality of layers, an innermost layer 5 to be arranged on the battery element 20 side, a barrier layer 6, and an outermost layer 8. The barrier layer 6 is arranged between the innermost layer 5 and the outermost layer 8. In this embodiment shown in FIG. 2, the number of layers is 3 (three).

These layers 5, 6, and 8 are integrally bonded by a dry lamination method. In detail, the innermost layer 5 and the barrier layer 6 to be overlapped with each other are bonded by an adhesive agent 9 interposed between them, and the barrier layer 6 and the outermost layer 8 to be overlapped with each other are bonded by an adhesive agent 9 interposed between them.

The thickness of the packaging film 1 is not specifically limited, but may be preferably set within the range of 30 μm to 200 μm.

The barrier layer 6 is a metallic layer. The metallic layer is intended mainly to provide barrier performance to the packaging film 1, and is formed by a metallic foil. That is, the metallic layer is a metallic foil layer.

As the metallic foil, various kinds of metallic foils can be used, and an aluminum foil, a stainless steel foil, a nickel foil, a copper foil, or a titanium foil can be preferably used. Especially, as the metallic foil, it is preferable to use an aluminum foil. The reasons are that an aluminum foil is excellent in flexibility, good in formability, light in weight, and available inexpensively. A more preferable aluminum foil is a soft aluminum foil.

In this disclosure, the term “aluminum” is used to include the meaning of both pure aluminum and aluminum alloys unless otherwise specifically defined. The term “nickel” is used to include the meaning of both pure nickel and nickel alloys unless otherwise specifically defined. The term “copper” is used to include the meaning of both pure copper and copper alloys unless otherwise specifically defined. The term “titanium” is used to include the meaning of both pure titanium and titanium alloys unless otherwise specifically defined.

Further, although the thickness of the metallic foil (i.e., metallic layer) is not limited, it is especially preferable to be 10 μm to 80 μm. The reasons are that a metallic foil having such a thickness has good barrier performance, good flexibility, and appropriate strength. The especially preferable thickness of the metallic foil is 15 μm to 40 μm.

Each of the innermost layer 5 and the outermost layer 8 is a thermal fusion resin layer as a sealant layer. Although the thermal fusion resin layer is not limited, it is preferably formed by a polyolefin-based resin film. As the polyolefin-based resin, polypropylene (PP), polyethylene (PE), ionomer resin, ethylene-ethyl acrylate copolymer resin (EEA), ethylene-vinyl acetate copolymer resin (EVA), etc., can be used. It is especially preferable to use polypropylene (PP) for the reasons that polypropylene is excellent in, for example, flexibility, electrolyte resistance (e.g., electrolyte solution resistance, durability (erosion resistance, corrosion resistance) against solid electrolyte), and sealing performance after heat-welding.

Although the thickness of the thermal fusion resin layer is not limited, it is preferable to be 10 μm to 80 μm for the reasons that, for example, strong and assured head-welding can be attained. The especially preferable thickness thereof is 30 μm to 50 μm.

Each adhesive agent 9 has electrolyte resistance. As the adhesive agent 9, it is preferable to use at least one agent selected from the group consisting of a polyolefin-based adhesive agent, an epoxy-based adhesive agent, a fluorine-based adhesive agent, and a polyurethane-based adhesive agent for the reasons that, for example, it is excellent in flexibility, electrolyte resistance, and water vapor barrier property. The most preferable adhesive agent is a polyolefin-based adhesive agent. Further, the especially preferable thickness of each adhesive agent 9 after bonding and curing is 0.1 μm to 10 μm.

Next, a tube-type packaging member 15A according to a first embodiment shown in FIG. 1 and its production method will be explained below.

The packaging member 15A is formed by bending the packaging film 1 having a predetermined shape, such as, e.g., a thin-plate shape, or a thin-belt shape, into a tube-shape round in cross-section. On the outer surface 2b of one end portion (in this disclosure, “one end portion” may be referred to as “first end portion”) 2 of both end portions 2 and 3 of the packaging film 1 in the bending direction, the inner surface 3a of the other end portion (in this disclosure, “the other end portion” may be referred to as “second end portion) 3 thereof is overlapped. In this overlapped state, the inner surface 3a of the second end portion 3 is air-tightly and fluid-tightly heat-welded to the outer surface 2b of the first end portion 2 continuously in the axial direction of the packaging member 15A. In this manner, a tube-type packaging member 15A is produced.

The production method of the packaging member 15A includes a step of preparing the packaging film 1, a step of bending the packaging film 1 into a tube-shape, a step of overlapping the inner surface 3a of the second end portion 3 on the outer surface 2b of the first end portion 2, and a heat-welding step of heat-welding the inner surface 3a of the second end portion 3 to the outer surface 2b of the first end portion 2.

The heat-welding step can be performed simultaneously with the overlapping step, or can be performed after the overlapping step. Further, although the heat-welding temperature is not limited, it is especially preferable to be within the range of 100° C. to 200° C. for the reasons that, for example, the heat-welding can be performed assuredly.

In the packaging member 15A of this first embodiment, the first end portion 2 of the packaging film 1 is arranged on the inner side of the packaging member 15A (i.e., the inner side of the packaging film 1 bent into a tube-shape), and the end face 2c of the first end portion 2 is not heat-welded to the inner surface 3a of the second end portion 3 and exposed to the inner side of the packaging member 15A. Even in this state, however, since each adhesive agent 9 of the packaging film 1 has electrolyte resistance, erosion of the adhesive agent 9 by the electrolyte at the end face 2c of the first end portion 2 of the packaging film 1 can be inhibited. With this, the service life of the packaging member 15A can be extended. Considering the possible metallic erosion of the end face 2c by the electrolyte from the barrier layer 6, it is preferable to preliminary subject the end portion (end face 2c) to a chemical conversion treatment or seal the end portion (end face 2c) by the head-welding film used for the innermost layer 5 and/or the outermost layer 8.

Further, the packaging member 15A has flexibility, and therefore the packaging member can be used as, for example, a packaging member for a string used for a cloth or a shoe (e.g., shoe string), or a packaging member for a wiring code.

The lithium-ion secondary battery 21 as a power storage device according to one embodiment of the present invention is of a linear-type (including a string-type) having flexibility, and the battery element 20 is accommodated and encapsulated in the packaging member 15A of this first embodiment. The accommodation of the battery element 20 in the packaging member 15A can be performed after bonding (thermally welding) both end portions 2 and 3 of the packaging film 1 bent into a tube-shape in the bending direction, or can be performed at the time of bending the packaging film 1 into a tube-shape.

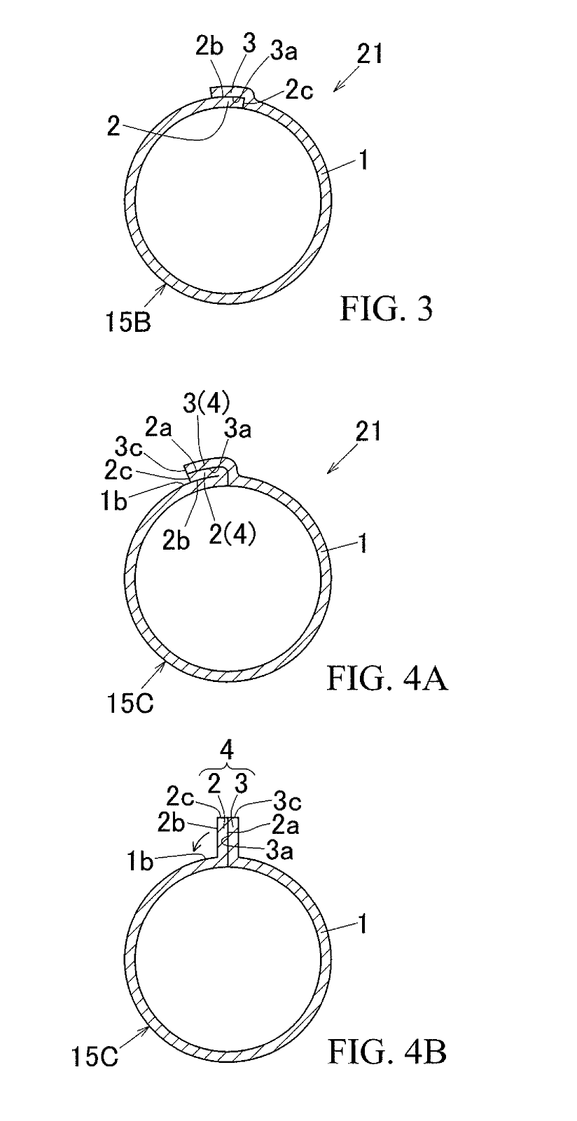

FIG. 3 shows a tube-type packaging member 15B according to a second embodiment of the present invention. In the figure, the same reference numeral is allotted to the corresponding element of the packaging member 15A of the aforementioned first embodiment. Hereinafter, the structures of the packaging member 15B of this second embodiment will be explained mainly focusing on the differences with the packaging member 15A of the first embodiment.

In the packaging member 15B of this second embodiment, the inner surface 3a of the other end portion (in this disclosure, “the other end portion” may be referred to as “second end portion”) 3 of the packaging film 1 is also heat-welded to the end face 2c of the one end portion (in this disclosure, “one end portion” may be referred to as “first end portion”) 2 of the packaging film 1. With this, the end face 2c of the first end portion 2 is concealed or covered by the inner surface 3a of the second end portion 3 of the packaging film 1. The other structures of the packaging member 15B are the same as those of the packaging member 15A of the aforementioned first embodiment.

In the production method of the packaging member 15B of this second embodiment, in the heat-welding step, the inner surface 3a of the second end portion 3 of the packaging film 1 is heat-welded to the outer surface 2b of the first end portion 2 of the packaging film 1, and the inner surface 3a of the second end portion 3 is heat-welded to the end face 2c of the first end portion 2. The heat-welding of the inner surface 3a of the second end portion 3 to the outer surface 2b of the first end portion 2 and the heat-welding of the inner surface 3a of the second end portion 3 to the end face 2c of the first end portion 2 can be performed simultaneously or temporally-shifted.

In the packaging member 15B of this second embodiment, since the innermost layer 5 of the packaging film 1 and the outermost layer 8 thereof are each formed by a thermal fusion resin layer, the inner surface 3a of the second end portion 3 can also be heat-welded to the end face 2c of the first end portion 2 of the packaging film 1. By doing so, at the end face 2c of the first end portion 2 of the packaging film 1, it is possible to prevent erosion of the metal used for the barrier layer 6 by the electrolyte and also possible to further control erosion of the adhesive agent 9 by the electrolyte. With this, the service life of the packaging member 15B can be further extended.

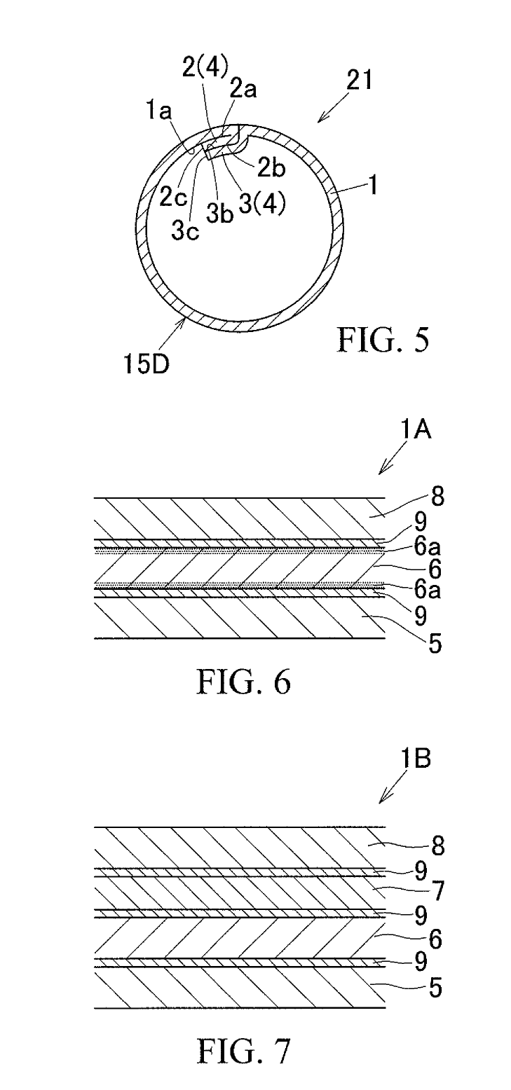

FIGS. 4A and 4B show a tube-type packaging member 15C according to a third embodiment of the present invention. In the figure, the same reference numeral is allotted to the corresponding element of the packaging member 15A of the aforementioned first embodiment. Hereinafter, the structures of the packaging member 15C of this third embodiment will be explained mainly focusing on the differences with the packaging member 15A of the first embodiment.

In the packaging member 15C of this third embodiment, as shown in FIG. 4A, the packaging film 1 is bent into a tube-shape. The inner surface 2a of the one end portion (in this disclosure, “one end portion” may be referred to as “first end portion”) 2 among both end portions 2 and 3 of the packaging film 1 in the bending direction and the inner surface 3a of the other end portion 3 (in this disclosure, “the other end portion” may be referred to as “second end portion”) are overlapped, and the first end portion 2 is folded back to the outer surface 1b side of the packaging film 1 bent into a tube-shape and the outer surface 2b of the first end portion 2 is overlapped on the outer surface 1b of the packaging film 1. In this state, the inner surface 2a of the first end portion 2 and the inner surface 3a of the second end portion 3 are heat-welded, and the outer surface 2b of the first end portion 2 is heat-welded to the outer surface 1b of the packaging film 1.

The production method of the packaging member 15C according to the third embodiment includes: a step of preparing a packaging film 1; a bending step of bending the packaging film 1 into a tube-shape; a first overlapping step of overlapping the inner surface 2a of the first end portion 2 of the packaging film 1 among both end portions 2 and 3 of the packaging film 1 in the bending direction and the inner surface 3a of the second end portion 3; a first heat-welding step of heat-welding the inner surface 2a of the first end portion 2 and the inner surface 3a of the second end portion 3; a second overlapping step of folding back the first end portion 2 to the outer surface 1b side of the packaging film 1 so as to overlap the outer surface 2b of the first end portion 2 and the outer surface 1b of the packaging film 1; and a second heat-welding step of heat-welding the outer surface 2b of the first end portion 2 to the outer surface 1b of the packaging film 1.

Although the order of performing the first overlapping step, the first heat-welding step, the second overlapping step, and the second heat-welding step is not limited, it is more preferable to perform in the order of the first overlapping step, the first heat-welding step, the second overlapping step, and the second heat-welding step. In this case, the method is as follows.

As shown in FIG. 4B, in the first overlapping step, the inner surface 2a of the first end portion 2 of the packaging film 1 and the inner surface 3a of the second end portion 3 thereof are overlapped on the outside of the packaging film 1 bent into a tube-shape. Next, in the first heat-welding step, the inner surface 2a of the first end portion 2 and the inner surface 3a of the second end portion 3 are heat-welded to thereby form a lug part 4 by integrally welding the first end portion 2 and the second end portion 3. Next, as shown in FIG. 4A, in the second overlapping step, the outer surface 2b of the first end portion 2 is overlapped on the outer surface 1b of the packaging film 1 by bending the lug part 4 so that the first end portion 2 is folded back to the outer surface 1b side of the packaging film 1. Next, in the second heat-welding step, the outer surface 2b of the first end portion 2 contained in the lug part 4 is heat-welded to the outer surface 1b of the packaging film 1. With these steps, the production of the packaging member 15C can be performed easily.

The first heat-welding step and the second heat-welding step can be performed simultaneously.

In the packaging member 15C of this third embodiment, since both the end face 2c of the first end portion 2 of the packaging film 1 and the end face 3c of the second end portion 3 of the packaging film 1 are arranged on the outside of the packaging member 15C without being arranged on the inner side of the packaging member 15C, there is no possibility that the end face exposed portion of the metallic layer as a barrier layer 6 and the adhesive agent 9 are eroded by the electrolyte at the end face 2c or 3c of each end portion 2 or 3 of the packaging film 1. With this, the service life of the packaging member 15C can be extended significantly.

Further, since the outer surface 2b of the first end portion 2 of the packaging film 1 is heat-welded to the outer surface 1b of the packaging film 1, the heat-welding can be performed from the outside of the packaging film 1 bent into a tube-shape. For this reason, as compared with the following fourth embodiment shown in FIG. 5, the heat-welding can be performed more easily.

FIG. 5 shows a tube-type packaging member 15D according to a fourth embodiment of the present invention. In the figure, the same reference numeral is allotted to the corresponding element of the packaging member 15A of the aforementioned first embodiment. Hereinafter, the structures of the packaging member 15D of this fourth embodiment will be explained mainly focusing on the differences with the packaging member 15A of the first embodiment.

In the packaging member 15D of this fourth embodiment, the packaging film 1 is bent into a tube-shape. The outer surface 2b of the first end portion 2 among both end portions 2 and 3 of the packaging film 1 in the bending direction and the outer surface 3b of the second end portion 3 thereof are overlapped, and the first end portion 2 is folded back to the inner surface 1a side of the packaging film 1 so that the inner surface 2a of the first end portion 2 is overlapped on the inner surface 1a of the packaging film 1. In this state, the outer surface 2b of the first end portion 2 and the outer surface 3b of the second end portion 3 are heat-welded, and the inner surface 2a of the first end portion 2 is heat-welded to the inner surface 1a of the packaging film 1.

The production method of the packaging member 15D according to the fourth embodiment includes: a step of preparing a packaging film 1; a bending step of bending the packaging film 1 into a tube-shape; a first overlapping step of overlapping the outer surface 2b of the first end portion 2 of the packaging film 1 among both end portions 2 and 3 of the packaging film 1 in the bending direction and the outer surface 3b of the second end portion 3; a first heat-welding step of heat-welding the outer surface 2b of the first end portion 2 and the outer surface 3b of the second end portion 3; a second overlapping step of folding back the first end portion 2 to the inner surface 1a side of the packaging film 1 so as to overlap the inner surface 2a of the first end portion 2 and the inner surface 1a of the packaging film 1; and a second heat-welding step of heat-welding the inner surface 2a of the first end portion 2 to the inner surface 1a of the packaging film 1.

Although the order of performing the first overlapping step, the first heat-welding step, the second overlapping step, and the second heat-welding step is not limited, it is more preferable to perform in the order of the first overlapping step, the first heat-welding step, the second overlapping step, and the second heat-welding step. In this case, the method is as follows.

In the first overlapping step, the outer surface 2b of the first end portion 2 of the packaging film 1 and the outer surface 3b of the second end portion 3 thereof are overlapped on the inner side of the packaging film 1 bent into a tube-shape. Next, in the first heat-welding step, the outer surface 2b of the first end portion 2 and the outer surface 3b of the second end portion 3 are heat-welded to thereby form a lug part 4 by integrally welding the first end portion 2 and the second end portion 3. Next, in the second overlapping step, the inner surface 2a of the first end portion 2 is overlapped on the inner surface 1a of the packaging film 1 by bending the lug part 4 so that the first end portion 2 is folded back to the inner surface 1a side of the packaging film 1. Next, in the second heat-welding step, the inner surface 2a of the first end portion 2 constituting the lug part 4 is heat-welded to the inner surface 1a of the packaging film 1. With these steps, the production of the packaging member 15D can be performed easily.

The first heat-welding step and the second heat-welding step can be performed simultaneously.

In the packaging member 15D of this fourth embodiment, the end face 2c of the first end portion 2 of the packaging film 1 and the end face 3c of the second end portion 3 are both exposed to the inner side of the packaging member 150. Even in this state, however, since the adhesive agent 9 of the packaging film 1 has electrolyte resistance, erosion of the adhesive agent 9 by the electrolyte at the end faces 2c and 3c of the end portions 2 and 3 of the packaging film 1 can be inhibited. With this, the service life of the packaging member 15D can be extended. Further, considering metallic erosion of the end face 2c from the barrier layer 6 by the electrolyte, it is more preferable to preliminarily subjecting the end portion (end face 2c) to a chemical conversion treatment or sealing the end portion (end face 2c) with a heat-welding film used for the innermost layer 5 and/or the outermost layer 8.

In the present invention, the packaging films 1 forming the packaging members 15A to 15D are each not limited to the structure shown in FIG. 2. Hereinafter, some preferable packaging films are shown.

FIG. 6 is a schematic enlarged cross-sectional view of a packaging film 1A according to another embodiment of the present invention. In this figure, the same reference numeral is allotted to the corresponding element of the packaging film 1 shown in FIG. 2. The structures of the packaging film 1A shown in FIG. 6 will be explained mainly focusing on the differences with the packaging film 1 shown in FIG. 2.

In the packaging film 1A shown in FIG. 6, the metallic layer which is a barrier layer 6 is formed by a metallic foil in which both surfaces in the thickness direction were subjected a chemical conversion treatment. Therefore, a chemical conversion treatment is subjected to both surfaces of the metallic foil. In FIG. 6, the portion of the metallic foil to which a chemical conversion treatment was subjected (i.e., chemical conversion treated portion) 6a is shown by dotted hatching. The treatment thickness of the chemical conversion treated portion 6a is not specifically limited, but is preferably set within the range of 0.1 μm to 10 μm. The other structures of the packaging film 1A shown in FIG. 6 are the same as those of the packaging film 1 shown in FIG. 2.

The method of the chemical conversion treatment is not limited, but specifically preferable methods can be exemplified as follows.

Method 1: A surface of the metallic foil to be subjected to a chemical conversion treatment (in this paragraph, referred to as “predetermined surface”) is subjected to a degreasing treatment. Thereafter, an aqueous solution of a mixture containing phosphoric acid, chromic acid, and at least one compound selected from the group consisting of metal salt of fluoride, and nonmetal salt of fluoride is applied to the predetermined surface of the metallic foil and dried. With this, the predetermined surface of the metallic foil is subjected to a chemical conversion treatment.

Method 2: A surface of the metallic foil to be subjected to a chemical conversion treatment (in this paragraph, referred to as “predetermined surface”) is subjected to a degreasing treatment. Thereafter, an aqueous solution of a mixture containing phosphoric acid, at least one resin selected from the group consisting of acrylic resin, a chitosan derivative resin and a phenolic resin, at least one compound selected from the group consisting of chromic acid and chromium (III) salt is applied to the predetermined surface of the metallic foil and dried. With this, the predetermined surface of the metallic foil is subjected to a chemical conversion treatment.

Method 3: A surface of the metallic foil to be subjected to a chemical conversion treatment (in this paragraph, referred to as “predetermined surface”) is subjected to a degreasing treatment. Thereafter, an aqueous solution of a mixture containing phosphoric acid, at least one resin selected from the group consisting of an acrylic resin, a chitosan derivative resin and a phenolic resin, at least one compound selected from the group consisting of chromic acid and chromium (III) salt, and at least one compound selected from the group consisting of metal salt of fluoride and nonmetal salt of fluoride is applied to the predetermined surface of the metallic foil and dried. With this, the predetermined surface of the metallic foil is subjected to a chemical conversion treatment.

By using the packaging film 1A shown in FIG. 6 as a packaging material for the packaging members 15A to 15D according to the aforementioned first to fourth embodiments, it is possible to inhibit not only erosion of the adhesive agent 9 by the electrolyte but also erosion of the metallic layer (barrier layer 6) by the electrolyte. With this, the service life of each of the packaging members 15A to 15D can be extended more assuredly.

In the present invention, the metallic foil forming the metallic layer can obtain the aforementioned effects as long as at least both surfaces of the metallic foil among all surfaces of the metallic foil are each subjected to a chemical conversion treatment, but in terms of more assuredly obtaining the aforementioned effects, it is more preferable that end faces of the metallic foil in the bending direction are each also subjected to a chemical conversion treatment.

FIG. 7 is a schematic enlarged cross-sectional view of a packaging film 1B according to still another embodiment of the present invention. In this figure, the same reference numeral is allotted to the corresponding element of the packaging film 1 shown in FIG. 2. The structures of the packaging film 1B shown in FIG. 7 will be explained mainly focusing on the differences with the packaging film 1 shown in FIG. 2.

The packaging film 1B shown in FIG. 7 includes, as one of a plurality of layers, an intermediate layer 7 arranged between the barrier layer 6 and the outermost layer 8. The barrier layer 6 and the intermediate layer 7 are bonded by the adhesive agent 9 interposed therebetween and having electrolyte resistance. The intermediate layer 7 and the outermost layer 8 are bonded by the adhesive agent 9 arranged therebetween and having electrolyte resistance.

The intermediate layer 7 is preferably formed by at least one film selected from the group consisting of a polyester-based resin film and a polyamide-based resin film.

As the polyester-based resin film, a biaxially stretched polyethylene terephthalate (PET), biaxially stretched polybutylene terephthalate (PBT), biaxially stretched polyethylene naphthalate (PEN), etc., can be used.

As the polyamide-based resin film, biaxially stretched nylon, etc., can be used.

By using the packaging film 1B shown in FIG. 7 as a packaging material for the packaging members 15A to 15D according to the aforementioned first to fourth embodiments, it is possible to improve the durability against an external force (piercing, bending, tension, etc.). With this, the service life of the packaging member 15A to 15D can be further extended.

The thickness of the intermediate layer 7 is not limited, but is especially preferable to be 12 μm to 50 μm for the reasons that the durability of the packaging members 15A to 15D (packaging film 1B) against an external force can be improved assuredly and the flexibility can be secured assuredly.

In the present invention, the intermediate layer 7 is not limited to be arranged between the barrier layer 6 and the outermost layer 6. For example, the intermediate layer 7 can be arranged only between the innermost layer 5 and the barrier layer 6, or can be arranged between the innermost layer 5 and the barrier layer 6 and between the barrier layer 6 and the outermost layer 8, respectively.

Further, in the packaging film 1B shown in FIG. 7, the metallic layer which is a barrier layer 6 can be formed by a metallic foil subjected a chemical conversion treatment as shown in FIG. 6.

Although several embodiments of the present invention are explained above, the present invention is not limited to any one of the aforementioned embodiments, and can be variously modified within a range not departing from the gist of the present invention.

Further, the present invention can be structured by combining two or more of the aforementioned first to fourth embodiments and the technical concepts of the present invention disclosed in FIGS. 2, 6 and 7.

Further, the packaging film according to the present invention is not limited to a film used as a packaging material for a packaging member for accommodating battery elements of a secondary battery such as a lithium-ion secondary battery, etc. For example, the packaging film according to the present invention can be a film used as a packaging material for a packaging member for accommodating capacitor elements of an electric double layer capacitor, or a film used as a packaging material for a packaging member for accommodating other power storage device elements.

Further, in the same manner, the tube-type packaging member according to the present invention is not limited to a member used as a packaging material for a packaging member for accommodating battery elements of a secondary battery such as a lithium-ion secondary battery, etc. For example, the packaging member according to the present invention can be a member used as a packaging material for a packaging member for accommodating capacitor elements of an electric double layer capacitor, or a member used as a packaging material for a packaging member for accommodating other power storage device elements.

Further, in the tube-type packaging member according to the present invention, the cross-sectional shape is not limited to a circular shape as shown in the aforementioned embodiments. For example, other than the above, the cross-sectional shape may be an oval shape, a flat circular shape, or a polygonal shape (for example, a triangular shape, a quadrangular shape, a pentagonal shape, a hexagonal shape, a seven triangular shape, an octagonal shape).

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

The present invention can be applicable to a packaging film for a power storage device (e.g., a lithium-ion secondary battery, an electric double layer capacitor) having flexibility, a tube-type packaging member for a power storage device, and a power storage device.

1. A packaging film for a power storage device, comprising:
a laminated film including a plurality of films, the laminated film being configured to be bent into a tube-shape to form a tube-type packaging member having flexibility,
wherein the plurality of films includes an innermost layer, an outermost layer, a barrier layer arranged between the innermost layer and the outermost layer, as a plurality of layers,
wherein the barrier layer is a metallic layer,
wherein the innermost layer and the outermost layer are each a thermal fusion resin layer, and
wherein an adhesive agent bonding overlapped layers of the plurality of layers has electrolyte resistance.

2. The packaging film as recited in claim 1,
wherein the adhesive agent is at least one adhesive agent selected from the group consisting of a polyolefin-based adhesive agent, an epoxy-based adhesive agent, a fluorine-based adhesive agent, and a polyurethane-based adhesive agent.

3. The packaging film as recited in claim 1,
wherein the metallic layer is formed by a metallic foil subjected to a chemical conversion treatment.

4. The packaging film as recited in claim 1,
wherein the plurality of layers further includes an intermediate layer arranged at least either between the innermost layer and the barrier layer and between the barrier layer and the outermost layer, and
wherein the intermediate layer is formed by at least one film selected from the group consisting of a polyester-based resin film and a polyamide-based resin film.

5. A tube-type packaging member for a power storage device, comprising:
the packaging film as recited in claim 1,
wherein the packaging film is bent into a tube-shape, the packaging film including a first end portion and a second end portion in a bending direction, and
wherein, in a state in which the first end portion of the packaging film and the second end portion of the packaging film are overlapped, the first end portion and the second end portion are heat-welded.

6. The tube-type packaging member as recited in claim 5,
wherein, in a state in which an outer surface of the first end portion of the packaging film is overlapped on an inner surface of the second end portion of the packaging film, the inner surface of the second end portion is heat-welded to the outer surface of the the first end portion.

7. The tube-type packaging member as recited in claim 6,
wherein an end face of the first end portion of the packaging film and the inner surface of the second end portion are heat-welded.

8. The tube-type packaging member as recited in claim 5,
wherein, in a state in which an inner surface of the first end portion of the packaging film and an inner surface of the second end portion of the packaging film are overlapped, and the first end portion is folded outwardly of the packaging film so that an outer surface of the first end portion is overlapped on an outer surface of the packaging film, the inner surface of the first end portion and the inner surface of the second end portion are heat-welded, and the outer surface of the first end portion is heat-welded to the outer surface of the packaging film.

9. The tube-type packaging member as recited in claim 5,
wherein, in a state in which an outer surface of the first end portion of the packaging film and an outer surface of the second end portion of the packaging film are overlapped, and the first end portion is folded inwardly of the packaging film so that an inner surface of the first end portion is overlapped on an inner surface of the packaging film, the outer surface of the first end portion and the outer surface of the second end portion are heat-welded, and the inner surface of the first end portion is heat-welded to the inner surface of the packaging film.

10. The tube-type packaging member as recited in claim 5,
wherein the adhesive agent is at least one adhesive agent selected from the group consisting of a polyolefin-based adhesive agent, an epoxy-based adhesive agent, a fluorine-based adhesive agent, and a polyurethane-based adhesive agent.

11. The tube-type packaging member as recited in claim 5,
wherein the metallic layer is formed by a metallic foil subjected to a chemical conversion treatment.

12. The tube-type packaging member as recited in claim 5,
wherein the plurality of layers further includes an intermediate layer arranged at least either between the innermost layer and the barrier layer and between the barrier layer and the outermost layer, and
wherein the intermediate layer is formed by at least one film selected from the group consisting of a polyester-based resin film and a polyamide-based resin film.

13. A power storage device, comprising:
the tube-type packaging member as recited in claim 5; and
a power storage device element having flexibility, wherein the power storage device is accommodated in the tube-type packaging member.

14. The power storage device as recited in claim 13,
wherein, in a state in which an outer surface of the first end portion of the packaging film is overlapped on an inner surface of the second end portion of the packaging film, the inner surface of the second end portion is heat-welded to the outer surface of the first end portion.

15. The power storage device as recited in claim 14,
wherein an end face of the first end portion of the packaging film and the inner surface of the second end portion are heat-welded.

16. The power storage device as recited in claim 13,
wherein, in a state in which an inner surface of the first end portion of the packaging film and an inner surface of the second end portion of the packaging film are overlapped, and the first end portion is folded outwardly of the packaging film so that an outer surface of the first end portion is overlapped on an outer surface of the packaging film, the inner surface of the first end portion and the inner surface of the second end portion are heat-welded, and the outer surface of the first end portion is heat-welded to the outer surface of the packaging film.

17. The power storage device as recited in claim 13,
wherein, in a state in which an outer surface of the first end portion of the packaging film and an outer surface of the second end portion of the packaging film are overlapped, and the first end portion is folded inwardly of the packaging film so that an inner surface of the first end portion is overlapped on an inner surface of the packaging film, the outer surface of the first end portion and the outer surface of the second end portion are heat-welded, and the inner surface of the first end portion is heat-welded to the inner surface of the packaging film.
